(19) United States
(12) Patent Application Publication
(10) Pub. No.: US 2013/0101738 A1
(43) Pub. Date: Apr. 25, 2013

(54) Apparatus and Method for Transporting Substrates

(71) Applicants: Jurgen Sollner, Wangen-Allgau (DE); Thomas Sauter, Neckargemund (DE); Jens Munkel, Hockenheim (DE); Christian Buchner, Baiersbronn (DE)

(72) Inventors: Jurgen Sollner, Wangen-Allgau (DE); Thomas Sauter, Neckargemund (DE); Jens Munkel, Hockenheim (DE); Christian Buchner, Baiersbronn (DE)

(73) Assignee: SCHMID TECHNOLOGY GMBH, SCHWETZINGEN (DE)

(21) Appl. No.: 13/578,568

(22) PCT Filed: Sep. 2, 2010
(86) PCT No.: PCT/EP10/62915

§ 371 Date: Jan. 7, 2013

(30) Foreign Application Priority Data
Feb. 11, 2010 (DE) 10 2010 008 233.3

(51) Int. Cl. B05C 13/02

(52) U.S. Cl. CPC B05C 13/02
USPC 427/256; 105/1.4; 118/500

(57) ABSTRACT

An apparatus for transporting silicon wafers in a horizontal transporting direction into a printing device has two transporting units, which each have a traversing device and a holding means thereon. At least two transporting units each with a holding means are provided, wherein the traversing devices of said units run next to each other along the transporting direction. The holding means are each formed and arranged in such a way that an unloaded holding means has space to pass by a holding means loaded with a silicon wafer. The traversing devices are rails and the holding means are carriages mounted thereon.

### FIELD OF APPLICATION AND PRIOR ART

The invention relates to an apparatus for transporting substrates, such as flat silicon wafers, along a direction of transport, and to a corresponding method, and to a device which uses such an apparatus.

Substrates such as silicon wafers are normally transported between different processing stations on a roller conveyor or conveying belts, more specifically in succession. In some circumstances, a plurality of roller conveyors or a plurality of rows of substrates can be provided side by side. This is known from DE 102006054846 A1 for example. However, a disadvantage is that the substrates can only be moved at the same speed. If, therefore, one substrate requires slightly more processing time or one processing station requires more time than a previous or subsequent processing station, this results in delays, which should actually be avoided in the expensive installations used.

Furthermore, it is known for example from DE 102005039100 A1 to introduce a plurality of substrates into a carrier and to then transport this carrier with all the substrates. In terms of delays, the same applies in this instance as with the second above-mentioned solution, specifically if a plurality of said carriers are to be moved in succession along a direction of transport.

### Object and Solution

The object of the invention is to create an apparatus of the type mentioned in the introduction as well as a method of the type mentioned in the introduction, and a device, with which problems of the prior art can be solved and with which, in particular, substrates can advantageously be moved along a direction of transport in a highly versatile manner and in particular so as to also assist processing devices used. This object is achieved by an apparatus having the features of claim 1, a method having the features of claim 9, and a device having the features of claim 8. Advantageous and preferred embodiments of the invention are disclosed in the further claims and will be explained in greater detail hereinafter. Some of the features below are stated merely for the apparatus or merely for the method. However, irrespective of this, they are to be applicable both to the apparatus and to the method. The wording of the claims is included in the content of the description by express reference.

In an advantageously horizontal plane of transport, the substrates are introduced or transported into a device for printing or coating the substrates and are then transported therethrough. In accordance with the invention a plurality of transporting units is provided, each of which has a traversing device with a holding means thereon. At least two such transporting units, each having a holding means, are provided, and the traversing devices thereof run side by side along the direction of transport. The direction of transport may be straight, but can also be bent or curved. Furthermore, in the case of this apparatus, substrates are advantageously moved in succession along the direction of transport, and not side by side. Should a plurality of substrates be moved side by side in this manner, a plurality of the apparatuses according to the invention therefore has to be arranged side by side. The holding means are each constructed and arranged in such a way that an empty second holding means can travel past or can be passed by or moved past a first holding means loaded with a substrate. For example, this can be achieved in that the holding means for holding or grasping a substrate are raised from a lower position into a higher position, either in part or completely, and thus hold the substrate. The substrate is thus situated above a first holding means in a normal or idle position, in which the second holding position can then travel past the substrate and the first holding means thereof without difficulty. The holding means, including the traversing devices thereof, are advantageously arranged side by side.

It is thus possible for a first holding means to grasp a substrate and to transport it, at the desired speed adapted to the respective process, in particular through an aforementioned device for printing or coating. The first holding means can then move the substrate within this device, again at the speed adapted to the process, and then exit the device and for example transfer the substrate to a next transporting device or a magazine. At this point, the second holding means of the device has already grasped a next substrate and drives it into the device for printing or coating. The first holding means, which is now free again, can then be moved past the second holding means and the substrate thereof before the device for printing and can grasp a next substrate. This next substrate can then be brought to the device at high speed, whereas the substrate still being processed in said device is only moved slowly along the direction of transport by its second holding means. Good adaptation is thus possible and the device is utilized to the optimum, since a further substrate is always brought by one of the holding means. Furthermore, in spite of the different speeds during transportation, with the invention it is possible for a holding means to transport the substrate continuously so that no transfers to different holding means have to be made, such transfers always being involved and being associated with a risk of damage to the substrate.

In an advantageous embodiment of the invention, the holding means may be what are known as “transporting carriages”. They can then advantageously be mounted on rails or the like as a traversing device and moved thereon. Individual rails or double rails can be provided for a transporting carriage. Linear drives, belt drives or air-bearing drives, which are known per se, can be used as a drive.

Two transporting units of this type are advantageously provided close to one another and side by side. The width thereof is still much less than the width of the substrates to be transported thereby.

In a further embodiment of the invention, the holding means can be designed to grasp or suction a substrate as a result of negative pressure or vacuum and to then move it. The substrates can thus be grasped relatively gently by the holding means. In an advantageous embodiment of the invention the holding means may have a trailing line for generation of the negative pressure by an external device, or a vacuum line so that they do not have to generate this negative pressure or vacuum themselves. Furthermore, the substrates may advantageously rest on the holding means, and then such a suction with negative pressure is merely used to prevent a change to the relative position of the substrate with respect to the holding means. To grasp a substrate, either the entire holding means can be raised with respect to the traversing device, or just part of said holding means, or a gripper part of the holding means.

In addition to a trailing line for the suction, further lines, in particular electrical supply lines, can run to the holding means in a similar manner. Said holding means may thus also have its own control units or further actuators. More specifically, it is thus also possible for the holding means to be constructed in such a way that it can position a held substrate with respect to the traversing device and can move it with a certain freedom of movement independently of a traversing movement of the holding means. This may be a range of a few millimeters or a few centimeters. To this end, aforementioned grippers or the like of the holding means may be provided with servomotors, piezo-actuators or the like. A rotary motion in the plane of the substrate is also possible. Should it be desired to raise or lower the substrate, this can be carried out by means of the previously described function in such a way that at least part of the holding means can in any case be raised and lowered. The holding means therefore does not necessarily have to receive the substrate in an exactly positionally accurate manner, but can itself adjust and position the substrate so to speak. This will be explained in greater detail hereinafter.

The substrates may be moved and held merely by the holding means. Alternatively, the substrates may also be moved along the direction of transport on elongate bearing means. For example, these can be bearing rails or roller bearings or wheel bearings on the outer sides. Air bearings can be used for particularly gentle bearing. These hold the substrate upwardly so that the holding means only have to basically transport the substrate, and do not have to take up the force of weight thereof. The aforementioned traversing devices for the holding means preferably run between these elongate bearing means.

A further aspect of the invention concerns a device for printing or coating a substrate, said device comprising or using an apparatus as described above. A substrate can then be introduced into the device using this apparatus. The device has a first processing station, at which a substrate transported thereto is measured, in particular in terms of its relative position to the holding means and/or to the traversing device and thus also to the device itself. A second processing station then follows, in which the substrate is then printed or coated, wherein a plurality of processing stations may also be provided for this purpose. In this second processing station, the substrate is moved past the holding means within small limits so as to align it with respect to a printing head or the like in order to achieve a predefined or necessary alignment. The printing or coating operation may then be assisted as a result of the holding means moving the aligned substrate forward and backward. Alternatively, the printing procedure can also be assisted by the possible, small relative movement of the substrate by the holding means with respect to the traversing device itself. The number of printing heads or processing stations required in the device for the printing process may thus possibly be reduced.

These and further features will become clear from the claims and also from the description and the drawings, wherein the individual features can be implemented in isolation or together in the form of sub-combinations in an embodiment of the invention and in other fields, and may constitute advantageous embodiments and embodiments which, themselves, are eligible for protection and for which protection is claimed here. The division of the application into individual sections and sub-titles does not limit the general validity of the statements made thereunder.

### BRIEF DESCRIPTION OF THE DRAWINGS

Exemplary embodiments of the invention are illustrated schematically in the drawings and will be explained in greater detail hereinafter. In the drawings:

FIG. 1 shows a plan view of a transporting apparatus for wafers according to the invention with a printing device,

FIG. 2 shows an enlarged view of an individual wafer on a transporting carriage on a transporting rail with options for movement of said wafer, and

FIG. 3 shows a side view similar to FIG. 2.

### DETAILED DESCRIPTION OF THE EXEMPLARY EMBODIMENTS

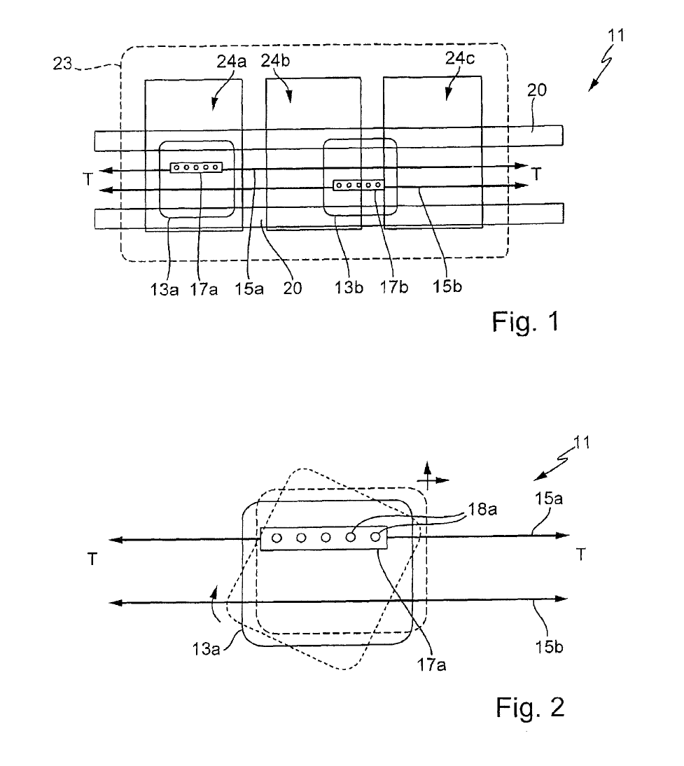

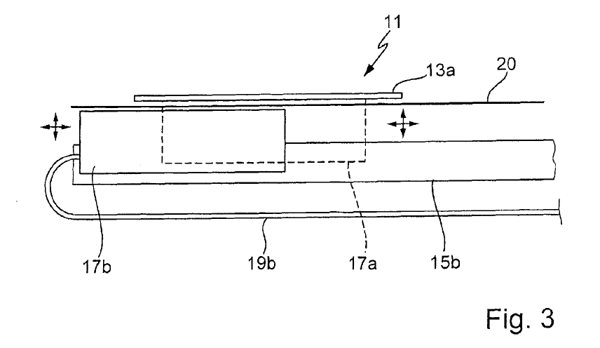

FIG. 1 shows a plan view of a transporting apparatus 11 according to the invention, with which wafers 13a and 13b as flat substrates can be transported or moved along a direction of transport T in a plane of transport, which is advantageously horizontal. The transporting apparatus 11 has two transporting rails 15a and 15b along the direction of transport T, on which transporting carriages 17a and 17b are provided. A single transporting carriage 17 is advantageously, but not necessarily, provided per transporting rail 15. The arrangement of the transporting carriage on the transporting rail 15 can also be seen from FIG. 3 for example and is explained in greater detail in this regard with reference to FIG. 3. Reference is made to the possible aforementioned embodiments, which are known in principle to a person skilled in the art. A transporting carriage 17 may overlap the transporting rail 15 in a virtually U-shaped manner, if said transporting rail is a single rail. Alternatively, two such transporting rails may also be provided close to one another per transporting carriage 17 so that said carriage runs on or between said rails.

The transporting carriages 17 have suction holes 18a and 18b, preferably five suction holes, on their surface or upper face, said holes being visible more clearly from the enlarged illustration in FIG. 2. As can be seen in FIG. 3, the transporting carriages can thus engage with the underside of a wafer 13, or the transporting carriage 17 lifts itself so far upwards with respect to the transporting rail 15 into a holding position that the wafer 13 is sucked against it. It can then be moved along the direction of transport T by the transporting carriage 17. A transporting carriage 17a according to FIG. 3 has a trailing line 19a for the suction function of the suction holes 18, said line being connected to a vacuum device or the like. Further electrical or signal lines for the transporting carriage 17 are advantageously coupled to the trailing line 19 and form a unit.

Air bearings 20 are provided laterally outside the transporting rails 15a and 15b, the wafers 13 resting on said air bearings via their upper and lower edge. It can be seen from the sectional illustration in FIG. 3 that the wafer 13a does not rest directly on the air bearing 20, but is slightly thereabove. This is because it has been raised slightly from the transporting carriage 17a. Furthermore, an air bearing by nature operates without direct contact. Other bearings could also be provided instead of such an air bearing 20, for example roller conveyors or bearing rails having a particularly smooth and gentle surface.

FIG. 2 further illustrates how the wafer 13a can be moved by means of the transporting carriage 17a on the transporting rail 15a. Naturally, this occurs along the direction of transport T, that is to say from left to right in the figures. It is also possible, as illustrated by a dashed line, for the wafer 13a to be slightly offset with respect to the transporting rail T, likewise along the direction of transport T and/or transverse thereto. The offset illustrated in this instance is illustrated in a largely exaggerated manner for the sake of clarity, but measures up to a few millimeters in practice. In addition to such a lateral and transverse offset, a wafer 13a may also be rotated about its central vertical axis, as illustrated by a dotted line. In this case too, an angle of rotation may be much smaller than that illustrated excessively in this instance for the sake of clarity, and may be just a few degrees. The purpose of this rotation, in particular together with the possible offset described above, is to slightly adjust the wafer 13a, independently of accurate reception on the transporting carriage 17a, in terms of its position relative to the transporting rail 15a, which is the measure so to speak for further devices as illustrated in FIG. 1. For example, this adjustment of the wafer 13a can be achieved by a split transporting carriage 17a, in which for example an upper sub-region is movable accordingly with the suction region or the suction holes 18a with respect to the lower sub-region, which is mounted on the transporting rail 15a. Alternatively, the bearing of the transporting carriage 17a on the transporting rail 15a itself could enable this movability. An adjusting movement along the direction of transport T may possibly be omitted, since it can be achieved by the normal movement of the transporting carriage 17a on the transporting rail 15a. The adjustment movement should merely be provided transverse thereto.

FIG. 3 also illustrates how the transporting carriage 17a can be raised slightly with respect to the transporting rail 15a. This can be seen from a comparison between the raised transporting carriage 17a, which carries the wafer 13a for movement thereof, and the other transporting carriage 17b. The transporting carriage 17a is illustrated in part by a dashed line, since it runs behind the transporting carriage 17b, including the transporting rail 15b thereof. The raising of the transporting carriage 17a is illustrated on the whole in this case with respect to the transporting rail 15a (not illustrated). For example, the entire transporting rail 15a could also be raised, but advantageously merely the transporting carriage 17a itself or again only part thereof is raised, for example an upper part. This can also be implemented by a person skilled in the art.

FIG. 1 illustrates how the transporting apparatus 11 leads through a printing device 23. This printing device 23, which is illustrated by a dashed line by way of example, comprises three processing stations 24a, 24b and 24c. For example, the processing station 24a is designed for measurement so that it is possible to establish the exact position of the wafer 13a relative to the processing station 24a and/or to the transporting rail 15a. This can be stored in a control system for the entire printing device 23 and also for the transporting apparatus 11. In a simple embodiment of the invention, the wafer 13a could then, on the basis of this data, be printed in a precisely defined manner in the subsequent printing heads of the processing stations 24b and 24c, which are designed to print the wafer 13, due to a corresponding adjustment of printing heads. The printing heads would then be adapted to the measured wafer so to speak. Alternatively, as a result of the options for movement, as illustrated in FIG. 2, by means of the transporting carriage 17a on the transporting rail 15a, the wafer 13 can be adjusted by the corresponding movements and brought into a precisely desired position. If the wafer 13a then travels into the processing stations 24b and 24c provided for printing, these stations can print more quickly and accurately and can be designed more simply, because the introduced wafers always lie in exactly the same way. The finished, printed wafer 13 then travels to the right along the direction of transport T by means of the transporting carriage 17a and is fed for further processing or for stacking (for storage) or the like.

As can be seen from FIG. 1, the wafer 13a on the left has just been measured and then adjusted if necessary. The wafer 13b on the right on the transporting carriage 17b has just left the processing station 24b to the left provided for printing and is travelling into the processing station 24c on the right, likewise provided for printing. Its movement can be completely independent however from that of the wafer 13a on the left, even in terms of speed. If the wafer 13b is also finished in the processing station 24c on the right and has been delivered to the right, the corresponding transporting carriage 17b can thus be lowered, in accordance with FIG. 3, and then moved to the left along the direction of transport T. It can then pass the transporting carriage 17a, including the wafer 13a on the left, without difficulty and can then grasp a new wafer to the left thereof. During this process, the wafer 13a is driven into the processing station 24b by the transporting carriage 17a, so that the processing station 24a on the left is free. A new wafer 13 is then transported into said processing station 24a, from the left by the transporting carriage 17b.

1. An apparatus for transporting substrates, such as flat silicon wafers, in a horizontal plane of transport along a direction of transport, comprising:
at least two transporting units, each of which has a traversing device and a holding means thereon,
wherein the traversing devices of each transporting unit run side by side along the direction of transport, and
wherein each of the holding means is constructed and arranged in such a way that an empty holding means passes by a holding means loaded with a substrate.

2. The apparatus as claimed in claim 1, wherein the holding means are transporting carriages.

3. The apparatus as claimed in claim 1, wherein the traversing devices are rails for moving or traversing the holding means thereon in a positionally accurate manner.

4. The apparatus as claimed in claim 1, wherein the holding means have a linear drive, a belt drive or an air-bearing drive over the traversing devices along the direction of transport.

5. The apparatus as claimed in claim 1, wherein the holding means are constructed to grasp or suction a substrate as a result of negative pressure or vacuum and to then move or transport it.

6. The apparatus as claimed in claim 1, wherein the holding means are constructed to position a held substrate with respect to the traversing device and/or to position the substrate independently of a movement of the holding means along the traversing device.

7. The apparatus as claimed in claim 1, wherein the substrates run along the direction of transport on elongate bearing means.

8. A device for printing or coating a substrate, said device having an apparatus as claimed in claim 1 for introducing and transporting a substrate, the device comprising:
a first processing station for measuring a substrate transported thereto in terms of its relative position to the holding means and/or to the traversing device, and
a second processing station for printing or coating the substrate,
wherein, in the second processing station, the substrate is moved by the holding means within small limits to assist the printing or coating operation.

9. A method for transporting flat substrates, such as silicon wafers, in a horizontal plane of transport along a direction of transport by means of an apparatus as claimed in claim 1, the method comprising:
grasping a substrate using the holding means on the traversing device of one of said transporting unit; and
moving the holding means along the direction of transport.

10. The method as claimed in claim 9, further comprising raising, slightly with respect to the traversing device, at least part of the holding means for grasping or holding a substrate.

11. The method as claimed in claim 9, wherein a second holding means without a substrate thereon is moved past or in front of a different, first holding means with a substrate thereon, from a position therebehind to receive or hold a further substrate thereon, wherein this occurs when the second holding means has brought a substrate to the end of a transport path, wherein the second holding means then transfers said substrate so as to move past the first holding means, with the substrate thereon, toward the front end of the transport path to receive the new substrate so as to move said substrate along the transport path.

12. The method as claimed in claim 9, measuring a position, relative to the holding means, of a substrate received or held on the holding means and storing the position in a control system.

13. The method as claimed in claim 9, wherein the holding means introduces the substrate into a device for printing or coating the substrate and, in a first step, the relative position of the substrate to the holding means is measured and, in a second step, the substrate is printed or coated,
wherein, by moving the substrate, the holding means is aligned with a printing head in a predefined relative position,
wherein the holding means moves the substrate relative to the printing head during the printing process, to assist the printing process.

14. The apparatus as claimed in claim 3, wherein one rail is provided per transporting unit.

15. The apparatus as claimed in claim 5, wherein the holding means are provided with a trailing line for generation of the negative pressure by an external device.

16. The apparatus as claimed in claim 6, wherein the holding means are constructed to position a held substrate by rotary movement in the plane of the substrate.

17. The apparatus as claimed in claim 6, wherein the holding means are constructed to position a held substrate by raising and lowering.

18. The apparatus as claimed in claim 6, wherein a raising and lowering of the holding means is used to move past a substrate received by different holding means.
